(19) United States
(12) Patent Application Publication
(10) Pub. No.: US 2010/0256808 A1
(43) Pub. Date: Oct. 7, 2010

(54) Method And Apparatus For Dispensing Medicine

(76) Inventor: John Hui, Chino, CA (US)

Correspondence Address: Cislo & Thomas LLP, 1333 2nd Street, Suite #500, Santa Monica, CA, 90401-4110, US

(21) Appl. No.: 12/418,307

(22) Filed: Apr. 3, 2009

(51) Int. Cl. G06F 17/00; B65D 83/00; G06F 7/00; G06F 3/01

(52) U.S. Cl. 700/225; 700/231; 221/133; 221/1; 715/702

(57) ABSTRACT

An automated medicine dispensing system comprising a housing unit; a dispensing unit attached to the housing, the dispensing unit comprising a pump to alter a pressure in the dispensing unit, and a nozzle operatively connected to the pump via a first tube; and a base positioned below the dispensing unit, the base comprising a plurality of receptacles, each receptacle operatively connected to a sensor to detect a quantity of medicine in each receptacle, and a dispensing outlet adjacent to at least one receptacle to dispense the medicine outside the housing unit. The base may be movable below the dispensing unit to select a desired medication. The dispensing unit may be movable over the base to select the desired medication.

### TECHNICAL FIELD

This invention relates to methods and devices that automatically dispense medicine and monitor medicine consumption.

### BACKGROUND

Even in a well developed society, with advanced technology and safe and effective medication, billions of dollars are wasted unnecessarily due to complications arising after treatment of an illness. A major cause of these complications is due to incomplete treatment; not on the part of the health care provider, but rather, due to patient non-compliance. Often times patients never fill their prescription, cannot identify their medication, cannot follow the instructions for taking the medication, or take other people's medication. Physicians may prescribe medication or physical therapy to treat a condition, but unless the patient complies with the prescription, the condition may re-occur or become exacerbated, thereby further increasing medical costs or even leading to death that could have been avoided.

To aid in patient compliance, devices have been developed to monitor when and how much medicine has been removed from a receptacle and to alert patients when its time to take the medication. In order to monitor the amount of medication taken, however, the patient must still identify the proper medication and dispense some amount of the medication. This may become increasingly more difficult for the elderly whose eyesight, memory, and judgment continue to deteriorate.

For the foregoing reasons there is a need for an automated medicine dispenser that can dispense the proper medication, in the proper amount, at the proper time, with the proper alert.

### SUMMARY

The present invention is directed to a method and apparatus for automatically dispensing the proper medication, in the proper amount, at the proper time to monitor medicine consumption and patient compliance. The medication compliance system comprises a support structure, a dispensing unit to dispense the medication, a base to separate multiple different medications, and a computer to execute instructions regarding the proper dispensing regimen. The dispensing unit is attached to the support structure via a plurality of directional rods on which the dispensing unit traverses. In some embodiments, the rods may be fixed and the base movable. The dispensing unit can then move over the proper medication and retrieve the proper dosage from the base or the base can move to place the proper medication under the dispensing unit. The base comprises a plurality of receptacles, and a dispensing outlet adjacent to the plurality of receptacles to dispense the medicine. Each receptacle may be in cooperation with a detector to detect a quantity of medicine in each receptacle. The computer comprises an input device to input a dispensing regimen, a storage device to store the dispensing regimen in a database, a processor to execute a command to automatically dispense the medicine according to the dispensing regimen, and an output device to communicate with a user.

### BRIEF DESCRIPTION OF DRAWINGS

FIG. 1 shows a perspective, partial cutaway view of an embodiment of the present invention;

FIG. 2 shows a perspective view of another embodiment of the present invention;

FIG. 3 shows a plan view of an embodiment of the present invention with the top removed to show the interior; and

FIG. 4 shows a front view of an embodiment of the present invention with the front wall removed to show the interior;

FIG. 5 shows a front view of another embodiment of the present invention with the front wall removed to show the interior;

FIG. 6 shows a perspective, partial cutaway view of another embodiment of the present invention; and

FIG. 7 shows a close-tip of an embodiment of the base.

### DETAILED DESCRIPTION OF THE INVENTION

The detailed description set forth below in connection with the appended drawings is intended as a description of presently-preferred embodiments of the invention and is not intended to represent the only forms in which the present invention may be constructed or utilized. The description sets forth the functions and the sequence of steps for constructing and operating the invention in connection with the illustrated embodiments. It is to be understood, however, that the same or equivalent functions and sequences may be accomplished by different embodiments that are also intended to be encompassed within the spirit and scope of the invention.

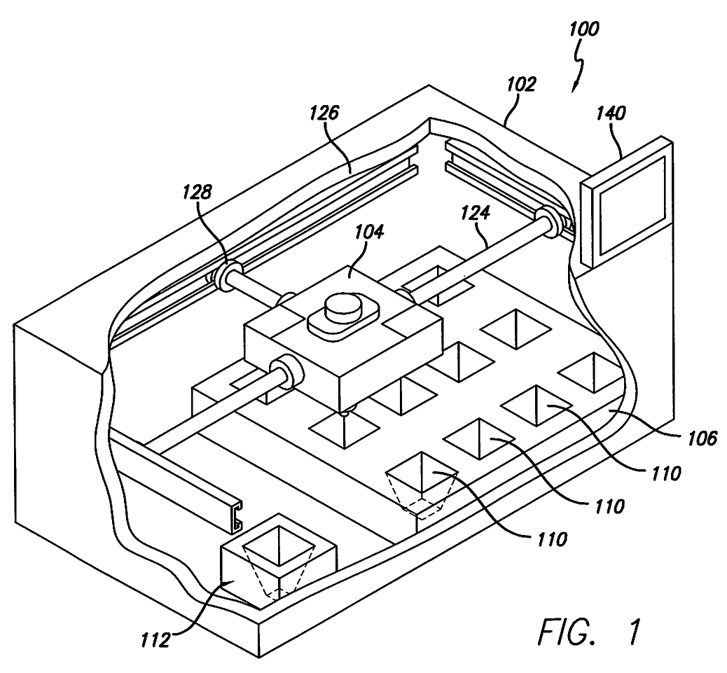

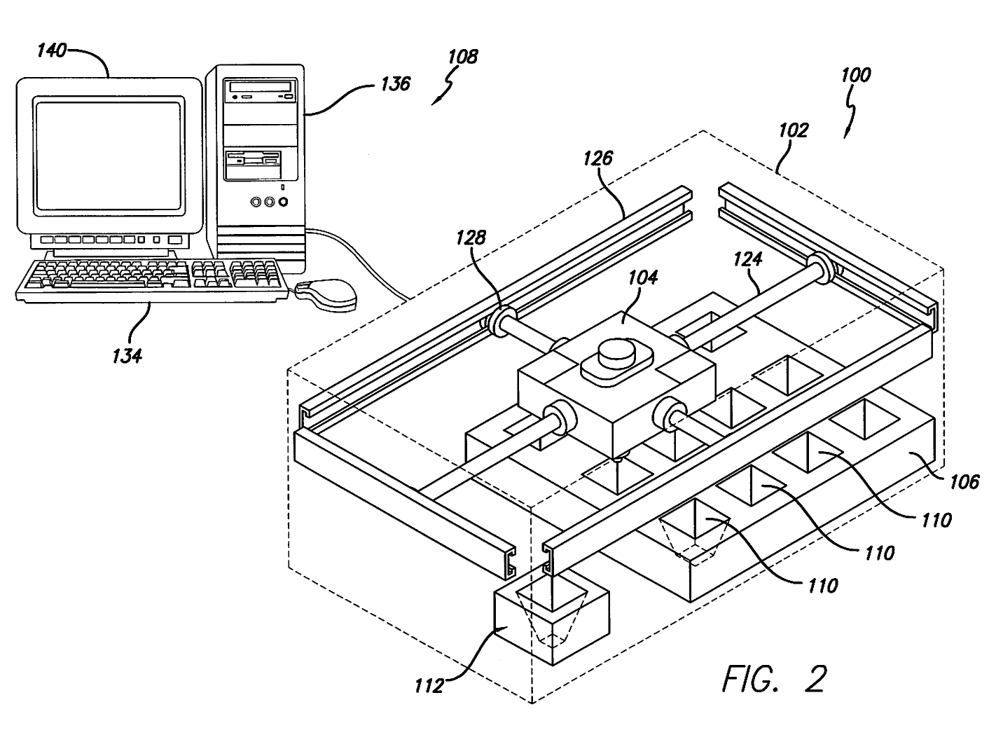

The present invention is directed towards an automated medicine dispensing system 100 that automatically dispenses an appropriate amount of medication for a user at the appropriate time pursuant to a dosage regimen. A user can be a patient, a health care provider, or a third party providing care for a patient. Referring to FIGS. 1 and 2, the automated dispensing system 100 comprises a support structure 102, a dispensing unit 104 attached to the housing 102, a base 106 below the dispensing unit 104, and a computer 108. The medication 10 is stored in the base 106 in individual receptacles 110. The dispensing unit 104 is capable of moving over the base 106 to access the individual receptacles 110 containing a specific medication 10, retrieving the appropriate amount of medication 10, and delivering the medication 10 to a dispensing outlet 112 to dispense the medication 10 from the medication dispensing system 100. The computer 108 is operatively connected to the dispensing system 100 to automate the dispensing process.

The housing 102 provides the foundation on which the dispensing unit 104 can be mounted. The housing unit 102 may be an airtight containment unit having at least one wall 102a, and a top 102b. The base 106 is positioned below the dispensing unit 104 and comprises a plurality of receptacles 110 to hold and store the medication 10. Each receptacle 110 may contain different types of indication 10 to treat different users or different conditions. The receptacles 110 may be integrally formed into the base 106 or may be independent containment units separable from the base 106.

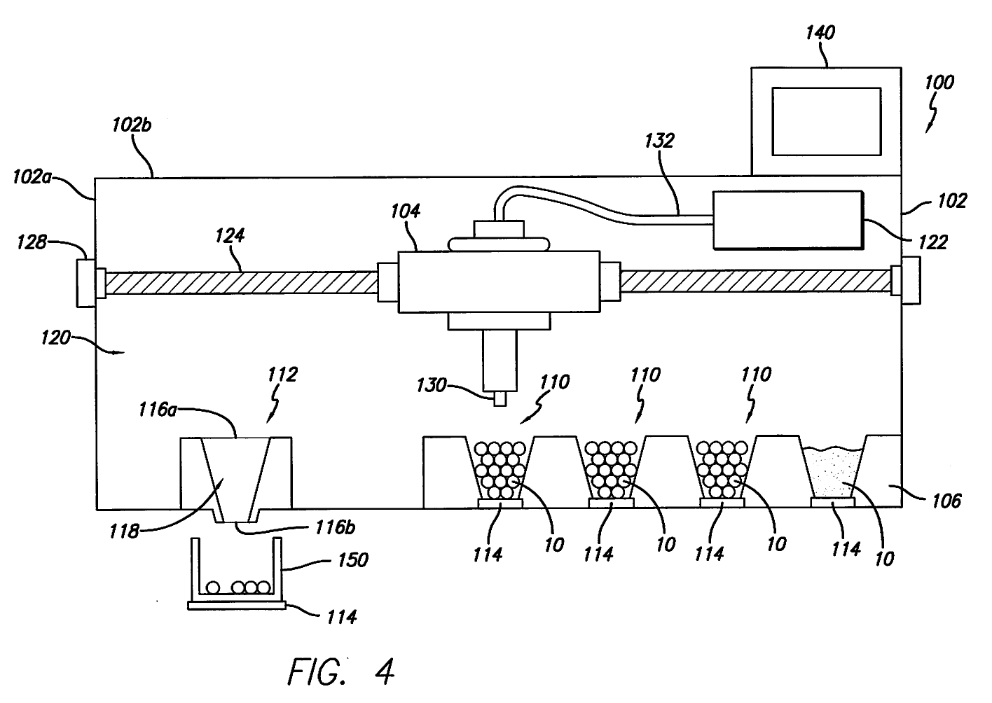

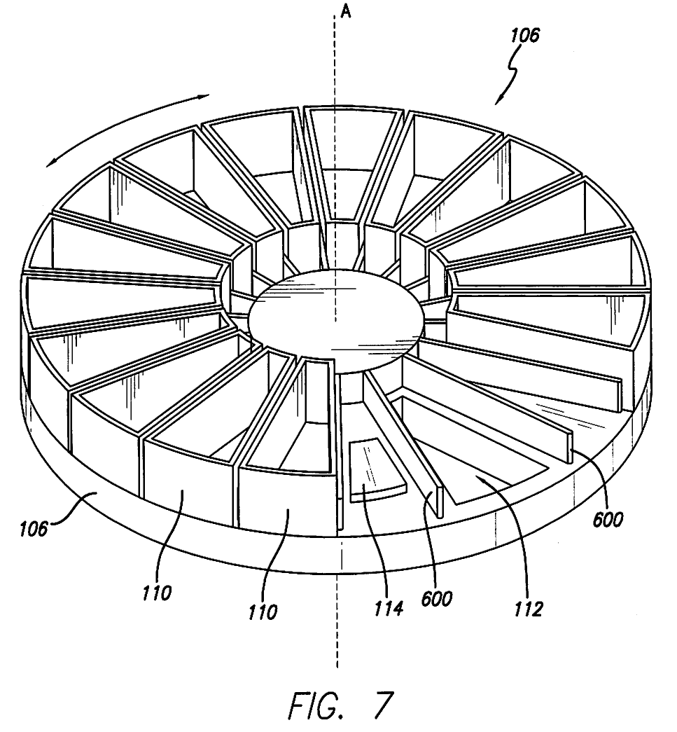

In some embodiments, each receptacle 110 may be operatively connected to a detector 114 to detect a quantity of the medicine 10 in each receptacle 110 as shown in FIGS. 4 and 7. In a preferred embodiment, the detector 114 is a scale. The detector 114 can be in communication with the computer 108 to determine and process the weight inside the receptacle 110 before medication 10 has been dispensed and the weight inside the receptacle 110 after medication 10 has been dispensed from the receptacle 110. The difference in weight can be compared to information stored in a database based on the identification of the medicine 10 to determine the amount of medication 10 that was dispensed and whether that amount was the appropriate dosage according the dosage regimen.

The base 106 further comprises a dispensing outlet 112 adjacent to the receptacles 110 to dispense the medicine 10 into a dispensing cup 150 outside the system 100. In some embodiments, the dispensing outlet 112 may comprise a door 116a to maintain cleanliness inside the system 100.

In some embodiments, the dispensing outlet 112 may comprise two doors 116a, 116b to maintain a particular atmospheric pressure inside the system 100, for example a vacuum. In Such embodiments, the dispensing outlet 112 comprises a first door 116a and a second door 116b below the first door 116a, thereby defining a dispensing chamber 118. The first door 116a maintains an airtight seal between the interior of the housing 120 and the dispensing chamber 118, and second door 116b maintains an airtight seal between the dispensing chamber and the exterior environment.

The two doors 116a, 116b open in series to dispense medication 10 while minimizing the change in pressure established inside the housing unit 120. When a medication 10 is ready to be dispensed, the first door 116a is opened while the second door 116b remains closed and the dispensing unit 104 can drop the medication 10 into the dispensing chamber 118. The first door 116a is then closed and the second door 116b is opened to dispense the medication 10 outside the dispensing chamber 118. Since the first door 116a is closed, however, atmospheric pressure outside the housing unit 120 is not allowed to equilibrate with the pressure inside the housing unit 120. Any change in atmospheric pressure inside the housing unit 120 due to the exposure to the dispensing chamber 118 is minimal and can be quickly and easily rectified.

In some embodiments, the dispensing chamber 118 may be connected to a pump 122 to equalize the atmospheric pressure in the dispensing chamber 118 and the housing unit 120 after the first and second door 116a, 116b are closed. Thus, when the first door 116a is open, the housing unit 120 will be exposed to the dispensing chamber 118 having the same atmospheric pressure as the housing unit 120. The first door 116a is then closed and the second door 116b can be opened, thereby expelling the medication. The dispensing chamber 118 is exposed to the outside atmospheric pressure. However, when the second door 116b is closed the atmospheric pressure in the inner chamber 118 can be re-established easily. Thus, the housing unit 120 provides a controlled environment in which the medication 10 can be stored.

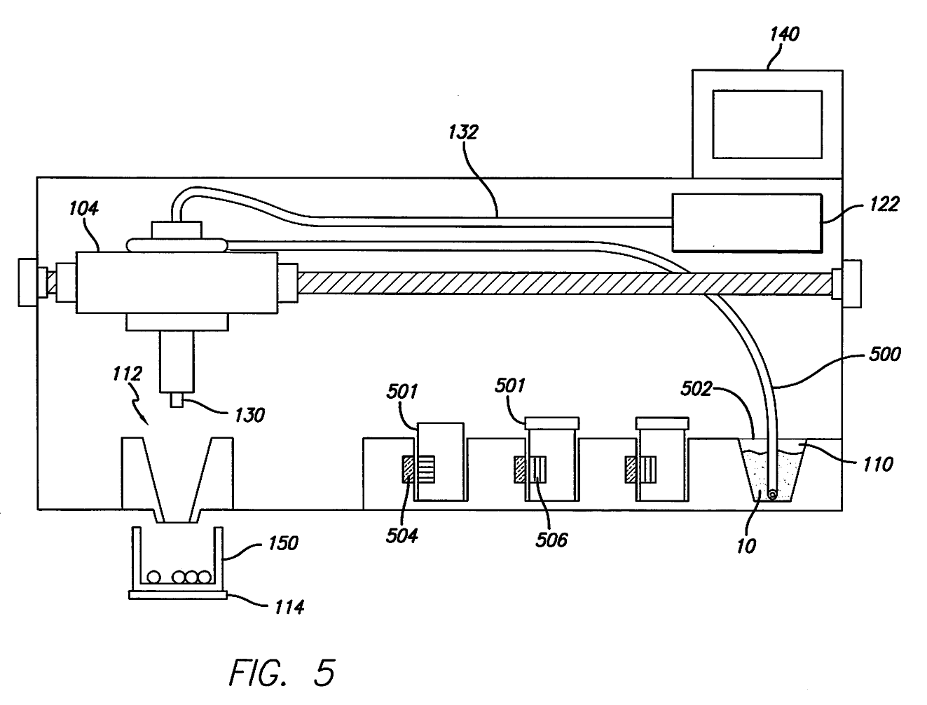

As shown in FIGS. 4 and 5, the dispensing cup 150 may also be connected to a sensor 114 to detect whether the dispensing cup has been removed. In particular, the sensor 114 would detect whether the medication 10 that had been dispensed had been removed prior to dispensing the next medication 10. A alert may be actuated if a user attempts to dispense medication while medication is still present or has not been removed from the tray from the prior dispense.

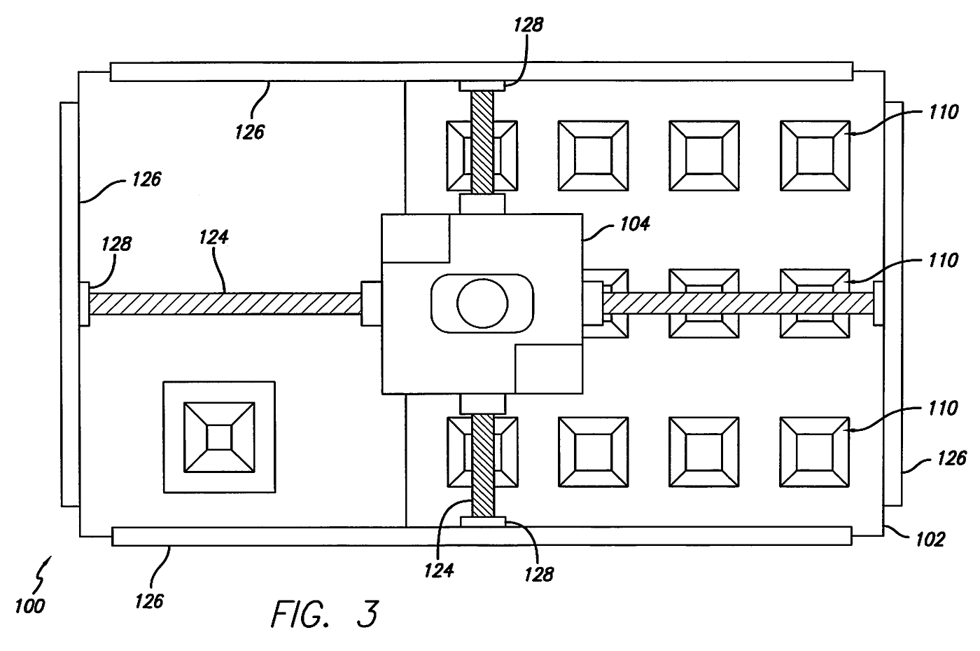

The dispensing unit 104 provides the means for removing the medication 10 from the housing unit 120 for a user's consumption. As shown in FIGS. 3-5, the dispensing unit 104 is movably attached to the support 102 to keep the dispensing unit 104 suspended yet allow the dispensing unit 104 to move in three dimensions throughout the interior of the housing unit 120. For example, the dispensing unit 104 may be attached to the support 102 by a plurality of rods 124, rails 126, slides 128, crevices, and the like along which the dispensing unit 104 can move in a forward-backward direction, left-right direction, and an up-down direction. The dispensing unit 104 may comprise a motor (not shown) operatively engaged with the support to provide the means for moving the dispensing unit in three dimensions a long the support 102. In some embodiments, the dispensing unit 104 may be fixed or immobilized and the base 106 movable.

The dispensing unit 104 further comprises a pump 122 and a nozzle 130 containing an orifice 200 connected to the pump 122 via an air tube 132. The pump 122 may be a bi-directional air pump to generate either negative pressure or positive pressure to create a vacuum or a burst of air, respectively, at the nozzle 130. Thus, when the dispensing unit 104 is positioned proximal to the medication 10, the pump 122 can be actuated to create negative pressure or a vacuum, thereby causing the medication 10 to be sucked into the nozzle 130. In some embodiments, the orifice 200 is sized to be smaller than the smallest solid medication 10 so that the medication 10 can be trapped at the nozzle 130 and not sucked into the nozzle 130. In this trapped configuration, the dispensing unit 104 can be moved throughout the housing unit 120 without dropping the medication 10. Once the dispensing unit 104 is positioned over the dispensing outlet 112 the pump 122 can be turned off to release the medication 10 from the nozzle 130 and dispensed into the dispensing outlet 112. In some embodiments, the pump 122 may be reversed to eject the medication 10 into the dispensing outlet 112. This may be particularly useful when the medication 10 is a liquid to assure the proper amount has been dispensed.

Utilizing a small orifice at the nozzle 130 will allow the dispensing unit 104 to accommodate medicines 10 of larger sizes. However, sufficient suction may not be created at a small orifice to hold large medication 10. In some embodiments, to compensate for different sized medications 10, the nozzle 130 may comprise a plurality of orifices of different sizes. The orifices may be provided adjacent to one another, for example arranged in a circular fashion along the periphery of a cylindrical nozzle with only one orifice aligned with the air tube 132 connected to the pump 122. The nozzle 130 may be rotated, manually or automatically, in a clockwise or counterclockwise fashion to expose an orifice of a different size and/or shape to the air tube 132 and pump 122.

In some embodiments, separate air tubes 132 may be attached to each orifice. Depending on the size of the medication 10 to be dispensed different air tubes can be turned on.

In some embodiments, the plurality of orifices may be concentrically arranged, wherein a smaller orifice is positioned deeper in the nozzle 130 relative to a larger orifice but connected to the same air tube 132 and pump 122 simultaneously. Smaller medications 10 will be trapped at the smaller orifices, while the larger medications 10 will be trapped at the larger orifices.

In some embodiments a plurality of nozzles 130 may be provided, each nozzle 130 having an orifice of a different size.

In some embodiments, the nozzle 130 may be telescoping so as to facilitate movement in the up-down direction.

In some embodiments, the automated medicine dispensing system 100 may utilize a dispensing tube 500 operatively connecting the receptacle 110 to the dispensing unit 104 to provide a conduit to transport the medicine 10 contained in the receptacle 110 to the dispensing unit 104. Thus, the nozzle 130 may be positioned over the dispensing outlet 112 while the dispensing tube 500 is moved from receptacle to receptacle in order to dispense the appropriate medication 10. In some embodiments, each receptacle 110 may have associated with it a separate dispensing tube 500. Thus, only the dispensing tube 500 associated with the desired medication 10 will be opened to allow the medication 10 to be dispensed at the nozzle 112. This may be particularly useful for liquid medications.

In some embodiments, the receptacle 110 comprises a dispensing cover 502 to cover the medicine 10 in the receptacle 110 and the dispensing tube 500 is operatively connected to the receptacle 110 via the dispensing cover 502.

In some embodiments, the receptacles 110 may be configured to receive standard medicine containers 501, such as the orange prescription bottles sold at pharmacies. The caps of the standard containers may be replaced with the dispensing cover 502 operatively connected to the dispensing tube 500. The receptacle 110 may further comprise a scanner 504 to read the prescription label 506 using optical character recognition technology or the like. In some embodiments, the prescription label 506 can further comprise a bar code associated with information regarding the dispensing regimen. Alternatively, a separate label may be printed at the pharmacy that can be attached to the medication bottle 501. The label 506 or bar code can be read by a scanner 504 within each receptacle 110 so that when the medicine bottle 501 is placed inside the receptacle 110, the label 506 or bar code can be read and the dispensing regimen recorded for that receptacle 110 and medication 10.

In some embodiments, a single scanner 504 may be attached to the dispensing system 100 to scan each medicine bottle 501 prior to placing the medicine bottle 501 into the receptacle 110. The scanner 504 can he programmed to correlate a particular scanning job with a specific receptacle 110 so that the proper dispensing regimen is associated with the proper medication 10.

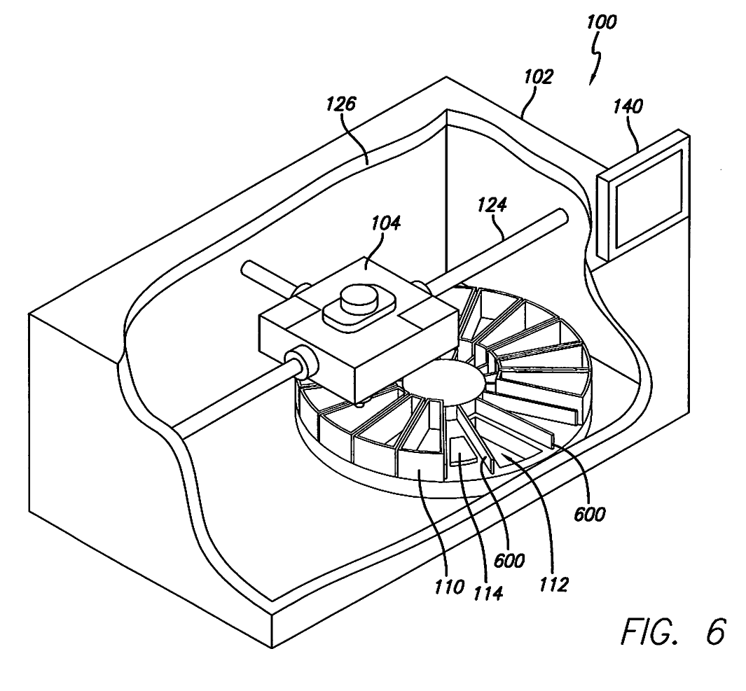

In some embodiments, the base 106 may be circular comprising a plurality of receptacles 110 and a dispensing outlet 112 that are wedge-shaped as shown in FIGS. 6 and 7. The base 106 may be rotatable about a central axis A perpendicular to the base 106 in a clockwise or counterclockwise direction as shown by the double arrow in FIG. 7. In this embodiment, the dispensing unit 104 remains stationary and the base 106 rotates to change the receptacle 110 under the dispensing unit 104. The dispensing unit 104 retrieves a medication 10 from the desired receptacle 110, the base 106 then rotates until the dispensing outlet 112 is positioned below the dispensing unit 104, and the medication 10 is released into the dispensing outlet 112. The housing unit 102 also comprises a housing outlet (not shown) positioned below the dispensing unit 104 such that when the dispensing outlet 112 is aligned with the dispensing unit 104, the dispensing outlet 112 is directly over the housing outlet to allow the medication to exit the dispensing system 100. Each individual receptacle 110 can be independently removed from the base 106 to replenish or change the medication or clean the receptacle. The receptacles can be locked or made tamper-resistant to avoid unauthorized access to the medication.

The base 106 may further comprise a plurality of separators 600 to separate individual receptacles 110 for easy replacement after removal.

The computer 108 facilitates automation of the present invention. The computer 108 comprises an input device 134, such as a scanner, keyboard, mouse, microphone, or the like to input a dispensing regimen, a storage device to store the information contained in the dispensing regimen in a database, a processor 136 to execute a command or program code to automatically dispense the medicine according to the dispensing regimen, and an output device 140 such as a monitor, display, speakers, and the like to communicate with a user.

The dispensing system 100 may further comprise an LCD display 140, preferably with a touch-screen. Any information transmitted to the computer 108 could also be displayed by the LCD display 160, such as the dosage regimen, warnings, communications with health care providers, and the like.

Numerous other devices and accessories can be connected to the dispensing system. A non-exclusive list includes a microphone, camera, digital picture frame, clock, and the like. Any of these devices and accessories can be connected via USB ports, serial ports, parallel ports, IEEE 1394 ports, or any other connection means generally used on computers.

The dispensing unit 100 may also have direct internet connections either through a local area network (LAN) or a wireless local area network (WLAN), such as Wi-Fi®. With internet connection, the dispensing unit 100 can access internet websites and download pictures to the digital picture frame. For example, a user could access flickr, memeo, facebook, or Costco's website to download pictures. Skype™ and other communication programs could be used to communicate with health care providers, friends, families, and the like. Blood pressure monitoring system may be attached to measure blood pressure and send via the internet to health care providers.

The dispensing regimen contains information regarding the patient and the medication to be taken. Information includes standard patient information acquired during any registration process related to health care, such as name, address, family members, physician information, medical history, allergies, current ailments and conditions, and the like. Information regarding the medication includes name and description of the medication, dosage to be taken, timing of dosage, other instruction regarding taking the medication, such as with water, food, etc., prescribing doctor, affiliated hospitals, side effects, cross-reactivity, warnings, contraindications, and the like. This information can be utilized by the computer to dispense the appropriate amount of medication, at the appropriate time, with appropriate instructions for the appropriate patient.

Software can be developed to be executed by a computer to implement these instructions to assure correct dosage of the appropriate medication is dispensed at the appropriate time for the designated patient. Any dispensing requests not in compliance with the dispensing regimen may result in the actuation of alerts or warnings. The level or intensity of the warning or alert may be governed by the gravity of the non-compliance. The gravity of the non-compliance can be determined by a health care professional. By way of example only, if a patient attempts to dispense his proper medication earlier than the designated time, then a mild warning is actuated to remind the patient that it is not the designated time to take his medication. If on the other hand, the patient is attempting to dispense a medication that he is allergic to or attempting to take multiple medications that should not be combined, then the warning or alert can be of greater intensity, such has louder alarms, brighter lights, or both.

The warnings or alerts may be audible and/or visual. They can be in the form of alarms of varying volume, pitch, tone, or frequency, or lights of varying brightness, color, or flashing lights to indicate the magnitude of non-compliance with the dispensing regimen. The warning can also be a textual message displayed on the LCD or computer screen. In some embodiments, the warnings may be specific or general oral messages pre-programmed for specific or general non-compliances.

The dispensing regimen can be inputted by a health care provider, such as the doctor, nurse, or pharmacist, from a remote location and transmitted to the medicine dispensing system 100, for example, via the internet or other telecommunication device. Alternatively, the user can input the information via keyboard or scanner. In some embodiments, the medicine container 501 may have a label 506, such as a bar code, associated with the dispensing regimen that can be scanned with a scanner 504, such as a bar code reader to input the dispensing regimen into the computer 108. Input of the dispensing regimen can be by any means such as a keyboard, touchpad, mouse, scanner, reader, microphone, and the like, or downloaded from the internet or loaded from an electronic storage media such as a disk drive, CD, DVD, flash drive, and the like. The user can also use the input device 134 to input his progress or symptoms into the computer 108 to update his dispensing regimen to help health care providers monitor the user's progress. Conversely, the health care provider can input information to update the dispensing regimen to adjust the dosage and inform the user of the adjustment.

As one example, a medicine container 501 may have a barcode 506 associated with a dispensing regimen. Each receptacle 110 in the medicine dispensing system 100 may have a bar code reader 504 positioned such that when the medicine container 501 is placed inside the receptacle 110 of the medicine dispensing system 100, the bar code reader 504 can read the bar code 506 and associate the dispensing regimen with the medication 10 contained in the current receptacle 110. Based on the dispensing regimen, the processor can execute a program code that causes the dispensing system 100 to dispense the appropriate amount of medication 10 from the appropriate container 501.

In another example, the medicine dispensing system 100 may be placed in a nursing home or the like. Each patient may have a wrist band or some other identification (ID) system associated with a specific dispensing regimen. The scanner 504 or reader may be on the outside of the dispensing system 100. Scanning or reading the patient's ID automatically dispenses the appropriate amount of the appropriate medication 10 from the appropriate receptacle 110 for that specific patient. Alternatively, the dispensing system 100 may indicate that it is not time to take the medication. Thus, the dispensing system 100 not only dispenses the appropriate amount of medication at the appropriate time, but also reduces the chances of overdosing as the dispensing system would not dispense the medication before the specified time and the patient may not have access to the medication otherwise. This also can reduce the occurrence of patients taking someone else's medication.

The output device 140 can be a screen, monitor, television, speaker, phone, or the like where the information can be heard or viewed by the user. Alarms can also be set to signal when the medication is to be taken. Once the medication is dispensed, the dispensing regimen is updated to monitor what medication was taken, by whom, when, where, how much, and why. This information can be transmitted to the health care provider via cell phone, personal digital assistant, computer, or any other like electronic device, to help the health care provider monitor a user's progress and compliance.

An emergency button may be incorporated into the medicine dispensing system to immediately alert a third party of an emergency. The emergency button may directly alert health care providers, family members, friends, 911, or any other third party that can respond to an emergency.

In some embodiments, a battery is provided as a back up energy source during times electric failures.

Thus, disclosed is also a method of automatically dispensing an appropriate dosage of medicine according to a dispensing regimen, comprising: providing a housing containing a plurality of medicines separated into a plurality of receptacles; moving a dispensing unit over a desired medicine receptacle containing a desired medicine or moving the desired receptacle underneath the dispensing unit; lowering the dispensing unit into the desired medicine receptacle, the dispensing unit comprising a nozzle cooperatively connected to a pump; creating a vacuum suction at the nozzle to draw the medicine into the nozzle; raising the dispensing unit above the desired receptacle; moving the dispensing unit over a dispensing outlet or moving the dispensing outlet underneath the dispensing unit; eliminating the vacuum suction at the nozzle or applying positive pressure to release the medicine into the dispensing outlet, thereby automatically dispensing the medicine.

The foregoing description of the preferred embodiment of the invention has been presented for the purposes of illustration and description. It is not intended to be exhaustive or to limit the invention to the precise form disclosed. Many modifications and variations are possible in light of the above teaching. It is intended that the scope of the invention not be limited by this detailed description, but by the claims and the equivalents to the claims appended hereto.

### INDUSTRIAL APPLICABILITY

This invention may be industrially applied to the development, manufacture, and use of medicine dispensing and monitoring system to automatically dispense medication and monitor medicine consumption.

What is claimed:

1. An automated medicine dispensing system, comprising:
a. a housing unit;
b. a dispensing unit attached to the housing unit, the dispensing unit comprising:
i. a bi-directional pump capable of creating a positive pressure and a negative pressure to alter a pressure in the dispensing unit, and
ii. a nozzle operatively connected to the bi-directional pump via a tube; and
c. a base positioned below the dispensing unit, the base comprising:
i. a plurality of receptacles, each receptacle operatively connected to a sensor to detect a quantity of medicine in each receptacle, wherein each receptacle is independently removable from the base; and
ii. a dispensing outlet adjacent to at least one receptacle to dispense the medicine outside the housing unit,
iii. wherein the base is rotatable about a central axis to selectively position one of the receptacles underneath the dispensing unit; and
d. a computing device configured to receive input for a dispensing regimen, to store the dispensing regimen in a database, to execute a command to automatically dispense the medicine according to the dispensing regimen, and to communicate with a user.

2. An automated medicine dispensing system, comprising:
a. a housing unit;
b. a dispensing unit attached to the housing, the dispensing unit comprising:
i. a pump to alter a pressure in the dispensing unit, and
ii. a nozzle operatively connected to the pump via a first tube; and
c. a base positioned below the dispensing unit, the base comprising:
i. a plurality of receptacles, each receptacle operatively connected to a sensor to detect a quantity of medicine in each receptacle; and
ii. a dispensing outlet adjacent to at least one receptacle to dispense the medicine outside the housing unit.

3. The automated medicine dispensing system of claim 2, wherein the base is rotatable about a central axis to selectively position one of the receptacles underneath the dispensing unit.

4. The automated medicine dispensing system of claim 2, wherein the dispensing unit is attached to the housing via a plurality of directional rods on which the dispensing unit traverses, and wherein the dispensing unit further comprises a motor operatively connected to the plurality of directional rods to move the dispensing unit in three dimensions.

5. The automated medicine dispensing system of claim 4, further comprising a dispensing tube operatively connecting at least one receptacle to the dispensing unit to provide a conduit to transport the medicine contained in the at least one receptacle to the dispensing unit.

6. The automated medicine dispensing system of claim 5, wherein the at least one receptacle comprises a dispensing cover to cover the medicine in the at least one receptacle and the dispensing tube is operatively connected to the at least one receptacle via the dispensing cover.

7. The automated medicine dispensing system of claim 2, wherein each receptacle is independently removable from the base.

8. The automated medicine dispensing system of claim 2 further comprising a LCD touch-screen for bi-directional communication between the automated medicine dispensing system and a user.

9. The automated medicine dispensing system of claim 2, wherein the pump is a bi-directional pump capable of creating a positive pressure and a negative pressure.

10. The automated medicine dispensing system of claim 2, wherein the dispensing outlet comprises a first door and a second door below the first door defining a dispensing chamber, the first door maintaining an airtight seal between the interior of the housing and the dispensing chamber, and second door maintaining an airtight seal between the dispensing chamber and the exterior of the chamber.

11. The automated medicine dispensing system of claim 2, wherein the sensor is a scale to measure the amount of medicine removed.

12. The automated medicine dispensing system of claim 2, further comprising a computing device comprising:
a. an input device to input a dispensing regimen,
b. a storage device to store the dispensing regimen in a database,
c. a processor to execute a command to automatically dispense the medicine according to the dispensing regimen, and
d. an output device to communicate with a user.

13. The automated medicine dispensing system of claim 12 further comprising an alert to warn of non-compliance with the dispensing regimen, wherein the intensity of the alert is proportional to the gravity of non-compliance.

14. The automated medicine dispensing system of claim 2, further comprising a plurality of nozzles, each nozzle comprising an orifice of a different size.

15. The automated medicine dispensing system of claim 2, wherein the nozzle comprises a plurality of orifices, each orifice of a different size.

16. The automated medicine dispensing system of claim 15, wherein the plurality of orifices are concentrically arranged, wherein a smaller orifice is positioned deeper in the nozzle relative to a larger orifice.

17. A method of automatically dispensing an appropriate dosage of medicine according to a dispensing regimen, comprising:
a. providing a housing containing a plurality of medicines separated into a plurality of receptacles;
b. aligning a dispensing unit over a desired medicine receptacle containing a desired medicine;
c. lowering the dispensing unit into the desired medicine receptacle, the dispensing unit comprising a nozzle operatively connected to a pump;
d. creating a vacuum suction at the nozzle to draw the medicine into the nozzle;
e. raising the dispensing unit away from the desired receptacle;
f. aligning the dispensing unit over a dispensing outlet;
g. eliminating the vacuum suction at the nozzle to release the medicine into the dispensing outlet, thereby automatically dispensing the medicine.

18. The method of claim 17, wherein the aligning steps are achieved by moving the dispensing unit over the desired receptacle or the dispensing outlet.

19. The method of claim 17, wherein the aligning steps are achieved by rotating the base to move the desired receptacle or the dispensing outlet underneath the dispensing unit.

20. The method of claim 17 further comprising inputting the dispensing regimen into a computer for processing.

21. The method of claim 20, wherein the inputting step is performed by a scanner reading a label on a medicine container.

22. The method of claim 17 further comprising creating a positive pressure at the nozzle to release and expel the medicine into the dispensing outlet.
